(19) United States
(12) Patent Application Publication
(10) Pub. No.: US 2026/0049572 A1
(43) Pub. Date: Feb. 19, 2026

(54) APPARATUS AND METHOD FOR MAINTAINING A GAS TURBINE ENGINE HAVING AT LEAST ONE PORT

(71) Applicants: General Electric Company, Evendale, OH (US); OLIVER CRISPIN ROBOTICS LIMITED, Altrincham (GB)

(72) Inventors: Todd William Danko, Niskayuna, NY (US); Trevor Owens Hawke, Bristol (GB); Chiara Mellucci, Bristol (GB); Ambarish J. Kulkarni, Glenville, NY (US); Andrew Crispin Graham, Badminton (GB)

(21) Appl. No.: 19/371,241

(22) Filed: Oct. 28, 2025

Related U.S. Application Data
(63) Continuation-in-part of application No. 17/713,371, filed on Apr. 5, 2022.

(51) Int. Cl. F02C 7/00

(52) U.S. Cl. CPC F02C 7/00; F05D 2230/72; F05D 2230/80

(57) ABSTRACT

An apparatus for maintaining a gas turbine engine having at least one port comprises a tool having an end effector to effect maintaining the gas turbine engine, the tool being configured to temporarily enter and exit the gas turbine engine via the at least one port and having a first portion and a second portion that are separated by at least a first area of articulation. A first inertial measurement unit is affixed with respect to that first portion and a second inertial measurement unit is affixed with respect to that second portion. A control circuit operably couples to those inertial measurement units and receives corresponding information regarding those portions of the tool. The control circuit can then process that received information to generate positional proprioception information as regards those monitored tool portions.

### CROSS-REFERENCE TO RELATED APPLICATIONS

This application is a continuation-in-part of application U.S. Ser. No. 17/713,371, filed Apr. 5, 2022, the contents of which are incorporated herein by reference in its entirety.

### TECHNICAL FIELD

These teachings relate generally to maintaining a gas turbine engine and more particularly to maintaining a gas turbine engine having at least one port.

### BACKGROUND

Gas turbine engines are complicated structures comprised of numerous component systems such as turbine blades, combustion chambers, and compressor stages. Many gas turbine engines include one or more ports such as borescope ports. A borescope port is a small, purpose-built access opening in the casing of a gas turbine engine that allows for internal inspection without disassembly. In particular, through these ports, technicians can insert a borescope (which is a flexible or rigid optical device equipped with a camera and light source) to perform remote visual inspections of corresponding internal components such as the aforementioned turbine blades, combustion chambers, and compressor stages.

### BRIEF DESCRIPTION OF THE DRAWINGS

Various needs are at least partially met through provision of the apparatus and method for maintaining a gas turbine engine having at least one port g described in the following detailed description, particularly when studied in conjunction with the drawings, wherein:

FIG. 1 comprises a block diagram as configured in accordance with various embodiments of these teachings;

FIG. 2 comprises a block diagram as configured in accordance with various embodiments of these teachings;

FIG. 3 comprises a flow diagram as configured in accordance with various embodiments of these teachings;

FIG. 4 comprises a schematic representation as configured in accordance with various embodiments of these teachings;

FIG. 5 comprises a schematic representation as configured in accordance with various embodiments of these teachings;

FIG. 6 comprises a schematic representation of portions of a gas turbine engine that include borescope ports; and

FIG. 7 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Typical known solutions as regards understanding the position(s) of various portions of an articulated tool can be relatively expensive, physically cumbersome, and/or insufficiently accurate. In some cases, known solutions are not sufficiently capable of tracking all of the degrees of freedom of movement that may characterize a given application setting.

Generally speaking, pursuant to these various embodiments, an apparatus for maintaining a gas turbine engine having at least one port can comprise a tool having an end effector to effect maintaining the gas turbine engine. (As used herein, the word “port” will be understood to refer to an opening that serves as an ingress/egress opening, with a borescope being a nonexclusive example thereof.) The tool can be configured to temporarily enter and exit the gas turbine engine via the at least one port and can have a first portion and a second portion separated by at least a first area of articulation, wherein the first area of articulation provides at least two degrees of freedom of movement. The tool can further comprise a first inertial measurement unit (IMU) affixed with respect to the first portion and a second IMU affixed with respect to the second portion. A control circuit can be operably coupled to the first IMU and the second IMU and can be configured to receive first information from the first IMU regarding the first portion and receive second information from the second IMU regarding the second portion while the tool effects the maintaining of the gas turbine engine. The control circuit can further be configured to process the first information and the second information to generate positional proprioception information as regards the first portion with respect to the second portion and to use such information to control stability of at least the end effector while the tool effects the maintaining of the gas turbine engine as a function, at least in part, of the positional proprioception information.

By one approach, the aforementioned first and second IMUs can include at least three gravity-based orientation sensors and at least three non-gravitational acceleration sensors.

By one approach, the aforementioned first area of articulation can provide at least three degrees of freedom of movement.

By one approach, at least a portion of the aforementioned tool is contained within a flexible cover.

By one approach, the control circuit is configured to generate the positional proprioception information as a function, at least in part, of sensor fusion. The technique may make use of the output of an IMU sensor or sensors to provide high bandwidth, high resolution updates to a positional measurement taken at a much lower rate by an optical sensor. For example, a borescope may include an optical sensor (either an electronic optical camera integrated circuit or an optical path such as a lens or a fiber optic bundle). Machine vision methods involving the processing of image information may be used to localize the optical sensor with respect to the gas turbine engine internal components and spaces. However, such localization necessarily requires substantial data transfer and processing, resulting in low bandwidth positional updates, based on the optical sensor alone. The update rate may be in the range of 1-30 frames per second, typically. Between each successive image capture (and the processing output), an IMU sensor or sensors also mounted on the borescope may provide high bandwidth updates to each positional estimate from the optical sensor. The bandwidth of these updates may be on the order of hundreds of updates per second, for example between 100 updates per second and 1000 updates per second. While the IMU provides high bandwidth updates, the signal/noise ratio in the unfiltered output signal of an IMU is typically unfavourable at high bandwidth, and the noise would result in errors which, if allowed to accumulate, would result in drift in position estimation. Each successive image may therefore be used to reset the position estimate. In such a manner, a low drift, high bandwidth positional estimate may be obtained by fusing the outputs of different sensors with different characteristics and physics.

By one approach, the control circuit is configured to generate the positional proprioception information without use of through-drivetrain information.

By one approach, the aforementioned maintaining comprises inspecting an internal feature of the gas turbine engine while at least the first portion of the tool is fully disposed within the gas turbine engine and within the at least one port.

By one approach, the aforementioned maintaining comprises repairing an internal feature of the gas turbine engine while at least the first portion of the tool is fully disposed within the gas turbine engine and within the at least one port. By one approach, that repairing comprises at least one of:
surface preparation of a surface of an internal feature of the gas turbine engine;
applying a material to an internal feature of the gas turbine engine;
removing material from an internal feature of the gas turbine engine;
joining materials within the gas turbine engine.

By one approach, the control circuit is configured to navigate the tool within at least one tightly confined internal space within the gas turbine engine as a function, at least in part, of the positional proprioception information to a location where the tool can effect the maintaining of the gas turbine engine.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

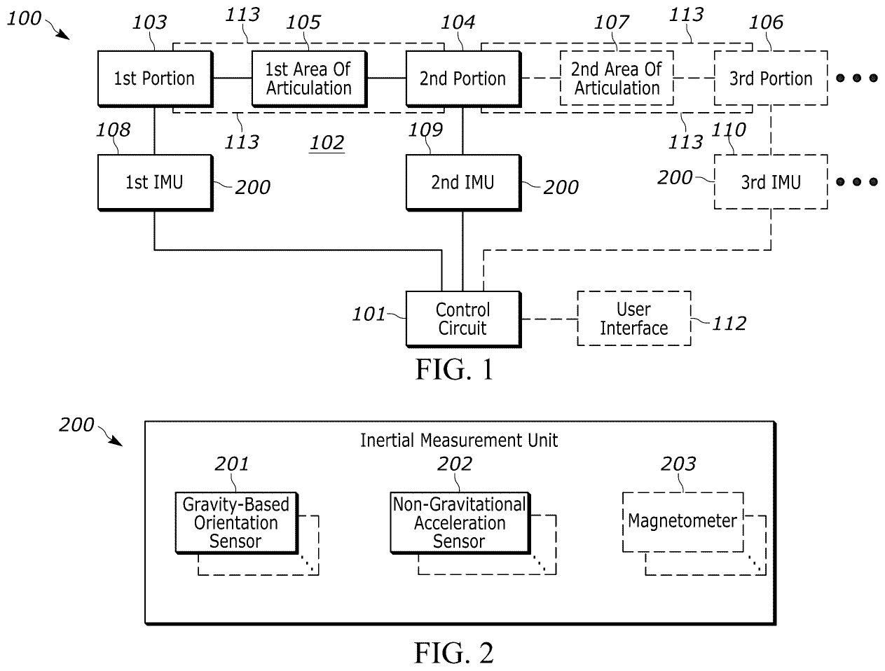

These and other benefits may become clearer upon making a thorough review and study of the following detailed description. Referring now to the drawings, and in particular to FIG. 1, an illustrative apparatus 100 that is compatible with many of these teachings will now be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory. This memory may be integral to the control circuit 101 (as in the illustrated embodiment) or can be physically discrete (in whole or in part) from the control circuit 101 as desired. This memory can also be local with respect to the control circuit 101 (where, for example, both share a common circuit board, chassis, power supply, and/or housing) or can be partially or wholly remote with respect to the control circuit 101 (where, for example, the memory is physically located in another facility, metropolitan area, or even country as compared to the control circuit 101).

This memory can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

If desired, the control circuit 101 can also operably couple to a network interface that may, as in the illustrated embodiment, be an integral part of the control circuit 101. So configured the control circuit 101 can communicate with other elements (both within the apparatus 100 and external thereto) via the network interface. Network interfaces, including both wireless and non-wireless platforms, are well understood in the art and require no particular elaboration here.

By yet another optional approach (in lieu of the foregoing or in combination therewith) the control circuit 101 may operably couple to a user interface 112. This user interface can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In this illustrative example, the apparatus 100 also comprises a tool 102 having at least a first portion 103 and a second portion 104 that are separated by a first area of articulation 105. In a typical application setting, these portions 103 and 104 will be solid, but these teachings are flexible in practice and may accommodate other possibilities. By one approach the first portion 103 connects physically to the second portion 104 via that first area of articulation 105 as a discrete point of rotation. In other embodiments, the area of articulation may be that of a soft or continuum robot so that rotations between 103 and 104 do not occur a discrete points, but are rather dispersed over an area of flexible material 113 that at least partially, or completely, covers that/those area(s).

These teachings will accommodate various approaches to the aforementioned articulation. By one approach, the first area of articulation 105 provides at least two degrees of freedom of movement. By another approach, the first area of articulation 105 provides at least three degrees of freedom of movement (such as, for example, pitch, roll, and yaw). There are various approaches to articulation that are known in the art including resolute coupling, share, extension, contraction, and so forth. As the present teachings are not overly sensitive to any particular selections in these regards, further elaboration is not provided here regarding any particular form or modality of articulation.

These teachings will optionally accommodate a tool 102 having other portions and/or additional areas of articulation. As one illustrative example, and as shown in FIG. 1, the tool 102 may have a third portion 106 that is separated from the second portion 104 but which is connected thereto by a second area of articulation 107. As another illustrative example (not shown), a third portion could be separated from the first portion 103 but connected thereto by a second area of articulation.

In this illustrative example, a first inertial measurement unit (IMU) 108 is affixed with respect to the first portion 103 and a second inertial measurement unit 109 is affixed with respect to the second portion 104. To the extent that there are other tool portions that are separated from other tool portions by intervening areas of articulation, additional inertial measurement units can be provided as desired. For example, and as optionally shown in FIG. 1, a third tool portion 106 may have a third inertial measurement unit 110 affixed thereto. These teachings will accommodate a variety of approaches as regards affixing these inertial measurement units to their corresponding tool portions. By one approach the inertial measurement units are directly connected to their corresponding portion using, for example, an attachment mechanism and/or an adhesive.

By one approach, and referring momentarily to FIG. 2, each inertial measurement unit 200 can comprise one or more gravity-based orientation sensors 201 and one or more non-gravitational acceleration sensors 202 (such as, for example, gyroscopic angular acceleration sensors or rate-gyroscopic sensors). If desired, each inertial measurement unit 200 can also optionally include one or more magnetometers 203. For many application settings, the inertial measurement unit 200 may comprise three gravity-based orientation sensors 201 and three non-gravitational acceleration sensors 202.

Referring again to FIG. 1, each of these inertial measurement units is communicatively coupled to the aforementioned control circuit 101 (for example, via a wireless or non-wireless modality). Generally speaking, inertial measurement units are electronic devices that measure and report a body's specific force, angular rate, and orientation. By providing three of each of the aforementioned sensors, an inertial measurement unit can provide information regarding each of the three principal axes, sometimes referred to as pitch, roll, and yaw. Configured as described above, these inertial measurement units can provide such information regarding each of their respective tool portions to the control circuit 101.

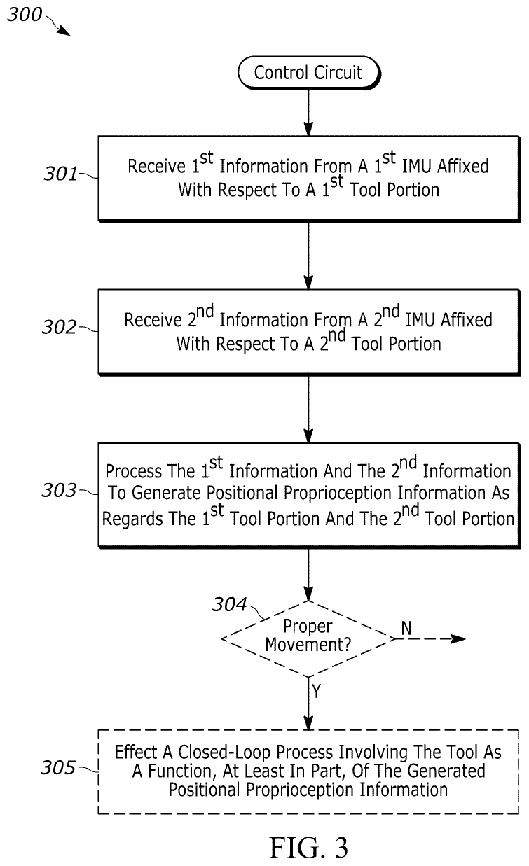

Referring now to FIG. 3, a process 300 that can be carried out by the aforementioned control circuit 101 will be described.

At block 301, the control circuit 101 receives first information from the aforementioned first inertial measurement unit 108 regarding the first portion 103. In this illustrative example this first information includes all of the aforementioned parameters pertaining to that first portion 103. At block 302, the control circuit 101 receives second information from the aforementioned second inertial measurement unit 109 regarding the second portion 104 where the second information again includes all of the aforementioned parameters pertaining to the second portion 104. (If and as the particular tool 102 includes additional portions such as the third portion 106 illustrated in FIG. 1, the control circuit 101 can receive additional corresponding information from the inertial measurement units (such as the illustrated third inertial measurement unit 110) regarding the monitored parameters for those additional portions.)

At block 303, the control circuit 101 processes the aforementioned received information to generate positional proprioception information as regards the monitored tool portions. By one approach, the control circuit 101 is configured to generate this positional proprioception information without use of through-drivetrain information. (“Through-drivetrain information” refers to data that is derived from the internal components and behavior of a drivetrain system-the mechanism that transmits power to the moving parts of a given machine. By analyzing how the drivetrain behaves-such as how far a motor has turned or how much torque is being applied-one can estimate the positional proprioception of the mechanism.) By one approach, the control circuit 101 is configured to generate this positional proprioception information by first determining an absolute orientation of each of the monitored tool portions independent of one another and then calculating a differential pose as a function of the determined absolute orientation of those monitored tool portions.

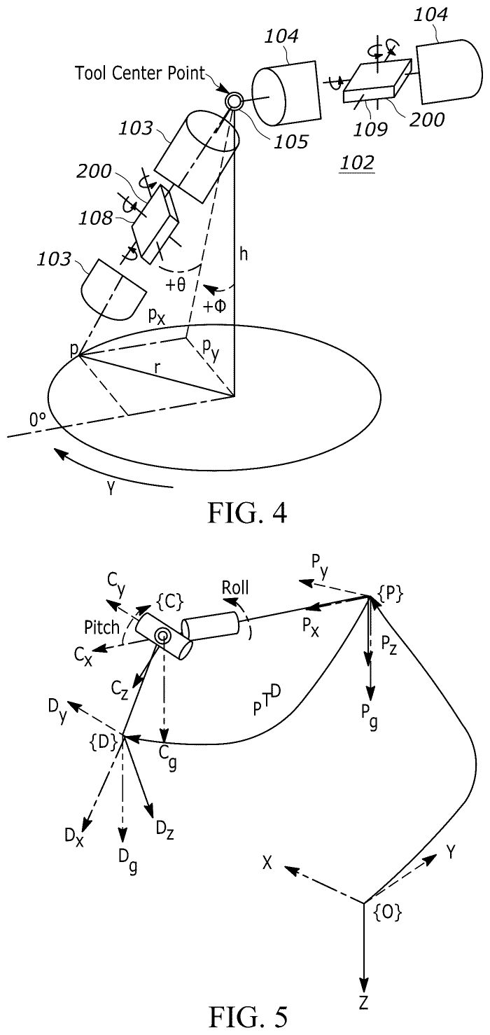

Referring momentarily to FIGS. 4 and 5, additional details regarding the generation of such positional proprioception information will be provided. It will be understood that no specific limitations regarding these teachings are intended in these regards and that such additional details are intended to serve only an illustrative purpose.

In this example, the apparatus 100 measures gravitational acceleration along each axis of proximal (P) and distal (D) accelerometers that comprise a part of corresponding inertial measurement units 200 (represented here by the aforementioned first and second inertial measurement units 108 and 109 discussed above).

The orthogonal components of the direction of gravity as measured by the proximal body (P_{g}) and distal body (D_{g}) are: P_{gx}, P_{gy}, P_{gz}, D_{gx}, D_{gy}, D_{gz}

For convenience, these teachings provide for creating an intermediate control point (C) coordinate system such that C rolls around the x axis of proximal body, P, and distal body, D, pitches around the y axis of C such that the orientation, including roll, pitch and yaw, of D can be solved by calculating the chain from P to C to D by way of constrained roll and pitch angles along with measured yaw angles as coupled to roll and pitch though the following described mechanism (wherein “T” is notation for a transform that includes the rotations that are to be estimated, such that _{P}T^{C} is the rotation from P to C and _{C}T^{D} is the rotation from C to D, and wherein Pₓ is the x axis of the sensor attached to the proximal body, P_{gx} is the component of the acceleration of gravity mapped onto Pₓ, P_{gy} and P_{gz} along with P_{gx} provide the components (and therefore orientation) of the acceleration gravity as measured by the proximal body sensor, and where the same is true for the distal body (there is no sensor on C)):

$$D = P {}_{P} {T}^{C} C {}_{C} {T}^{D}$$

Also in this example, motion is constrained such that:
_{P}T^{C} contains a fixed transform and roll rotation that is only around Pₓ, therefore Cₓ∥Pₓ ; and
_{C}T^{D} contains a fixed transform and pitch rotation that is only around C_{y}, therefore D_{y}∥C_{y}.

Gravitational accelerations can be mapped based on these constraints:

$${C}_{gx} = {P}_{gx}$$

$${C}_{gy} = {D}_{gy}$$

Roll around Pₓ is then the angle between C_{ϕ} and P_{ϕ}. Accordingly:

$$Roll = {C}_{ϕ} - {P}_{ϕ} where$$

$$tan {P}_{ϕ} = ( \frac{{P}_{qy}}{{P}_{qz}} ) and$$

$$tan {C}_{ϕ} = ( \frac{{C}_{gy}}{{C}_{gz}} ) = ( \frac{{D}_{gy}}{{D}_{gz}} )$$

In the foregoing, C_{gz} is not measured, but assuming a static system (where, for example, g is known and constant), this variable can be calculated from:

$$g = \sqrt{{C}_{gx}^{2} + {C}_{gy}^{2} + {C}_{gz}^{2}} = \sqrt{{P}_{gx}^{2} + {D}_{gy}^{2} + {C}_{gz}^{2}} \to {C}_{gz} = \pm \sqrt{- {P}_{gx}^{2} - {D}_{gy}^{2} + {g}^{2}}$$

Pitch around C_{y} is then the angle between D_{θ} and C_{θ}. Accordingly:

$$Pitch = {D}_{θ} - {C}_{θ} where$$

$$tan {C}_{θ} = ( \frac{- {C}_{gx}}{\sqrt{{C}_{gy}^{2} + {C}_{gz}^{2}}} ) = ( \frac{- {P}_{gx}}{\sqrt{{D}_{gy}^{2} + {C}_{gz}^{2}}} ) and$$

$$tan {D}_{θ} = ( \frac{- {D}_{gz}}{\sqrt{{D}_{gy}^{2} + {D}_{gz}^{2}}} ) .$$

Referring again to FIG. 3 and FIG. 4, the generated positional proprioception information, such as estimated roll and pitch angles between the first portion 103 and the second portion 104, for these various portions of the tool 102 can be employed in any of a variety of ways. As one example, and as illustrated at optional block 304, the control circuit 101 can use that generated information to determine whether the tool 102 is properly moving in an intended or otherwise safe and/or efficacious manner. For example, the control circuit 101 can determine whether the tool 102 exhibits an error in pose (which may also be in error in velocity (including angular velocity) if the tool 102 is in motion. When such is not the case, these teachings will accommodate taking any of a variety of corresponding actions. Examples include providing an alert or alarm and/or taking a specific action with respect to the tool 102 itself (for example, by halting further movement or by reversing a just-completed previous movement).)

As another example, and as illustrated at optional block 305, the control circuit 101 can effect a closed-loop process involving the tool 102 as a function, at least in part, of the generated positional proprioception information.

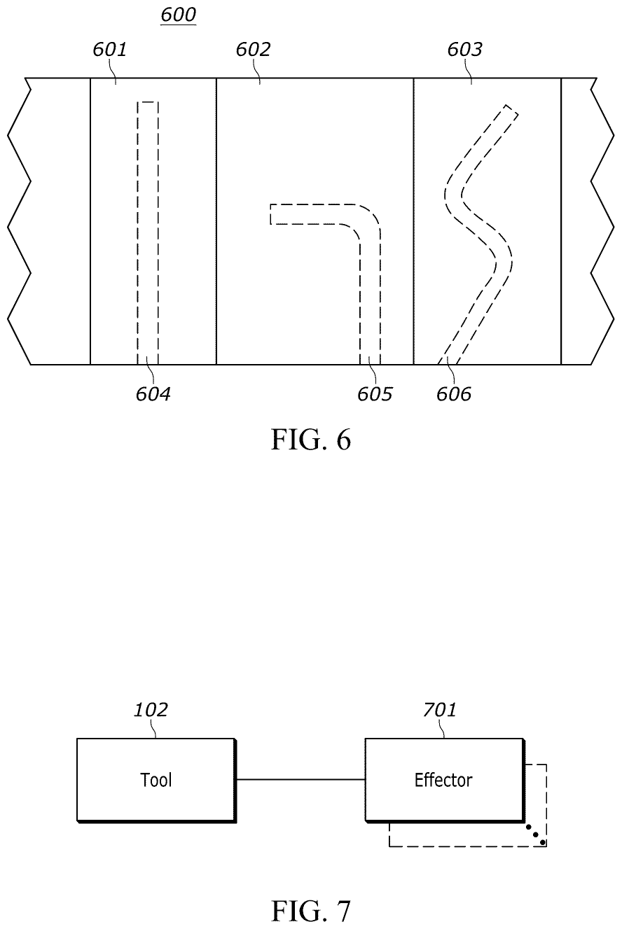

FIG. 6 presents a schematic representation of a gas turbine engine 600 having various component areas (some of which bear reference numerals 601, 602, and 603) such as, but not limited to, turbine blades, compressor stages, hot gas flow path areas (such as nozzle throat areas and combustor cavities/chambers, air flow paths including, for example, gooseneck paths between the exit of a low pressure compressor and the inlet of a high pressure compressor, and so forth). In this illustrative example, each of the aforementioned component areas has a corresponding borescope port 604, 605, and 606. Each of these borescope ports leads to a borescope pathway that can have any of a wide variety of shapes as generally schematically suggested by FIG. 6. In such an application setting, borescope ports are typically designed to accommodate borescopes having a diameter ranging from 3.8 mm to 6.35 mm depending on the engine model and inspection requirements. As one specific example, flexible borescopes having 4 mm diameter probes are sometimes used for tight-space inspections, such as navigating around high-pressure turbine blades or nozzle guide vanes.

Per the present teachings, the aforementioned tool 102 is designed, sized, and configured to fit within one or more corresponding borescope ports of a gas turbine engine. So configured, the tool 102 can be selectively inserted within such a borescope port and moved via the corresponding borescope path to an internal portion of the gas turbine engine. Accordingly, to suit the needs of a particular application setting, the tool 102 can be configured to accommodate corresponding features of the borescope path including, but not limited to, such features as an overall cross-sectional shape and/or other dimensional shapes and sizes, straight and/or curved surfaces, pathway gaps, and different pathway materials that can present differing surface textures (such as being relatively rough or smooth) and/or differing thermal properties.

As one example in the foregoing regards, the path may correspond to an air flow path such as a so-called gooseneck between the exit of a low pressure compressor and the inlet of a high pressure compressor or an air flow path comprising a cavity defined by a high pressure compressor casing and a high pressure compressor vane.

As another example in the foregoing regards, the path may correspond to a hot gas flow path such as (in reference to a combustor cavity) an annulus defined by an outer liner and an inner liner of a gas turbine combustor (where the annular cavity may have radii ranging from 8 inches to 60 inches and have a cavity height ranging from 2 inches to 8 inches), or a hot gas flow path such as a nozzle throat area having a cavity defined by the curved surfaces of nozzle airfoils and corresponding inner and outer bands forming discreet cavities with a height ranging from, for example, 0.5 inches to 6 inches, or a hot gas flow path through blade stages.

As yet another example in the foregoing regards, the path may correspond to any of a variety of secondary circuits, such as a cavity defined by an area between a combustor outer liner and the combustor case (for example, an annular cavity having a cavity height ranging from 0.25 inches to two inches), or a cavity defined by ducts and pipes from cooling flow offtakes in a high pressure compressor that feed cooling flow to high temperature components.

And as yet another example in the foregoing regards, the path may correspond to fuel nozzles within the gas turbine engine.

It will be understood that the specific dimensions and examples provided above are intended to serve an illustrative purpose and are not intended to suggest any particular limitations with respect to these teachings.

Pursuant to the foregoing descriptions, the above-described tool 102 can be configured to conduct one or more maintenance activities within the interior of a gas turbine engine, accessed via a port. (As used herein, the word maintenance will be understood to include at least inspecting and/or repairing some internal feature or component of the gas turbine engine.) With reference to FIG. 7, the tool 102 may be used in combination with one or more effectors 701, which may comprise an integral part of the tool 102 or may be selectively attached and detached from the tool 102 as desired. The effector 701 can itself be configured to carry out one or more desired maintenance activities within the interior of a gas turbine engine. An example of such a gas turbine maintenance tool is described in US Patent U.S. Pat. No. 10,920,590B2, which also describes a number of methods of anchoring such a maintenance tool apparatus within the interior of a gas turbine engine. The tool disclosed herein would be advantageous for use with the apparatus described in that patent. By one approach, therefore, either or both of tool 102 and end effector 701 may advantageously be equipped with an IMU as described herein for the purpose of navigation and localization of the tool and/or end effector within the engine so as to reach a specific location for the purpose of depositing the end effector in place. The IMU may be further used to ensure that the position of the end effector 701 is stable, i.e. that any vibrations of the tool resulting from its motion have been sufficiently dampened as to stop motion of the end effector, before the end effector is anchored to a location within the interior of the gas turbine engine, specifically to a rotor component such as a blade, a disk or a blisk. The damping used for this purpose or for any other purpose, for example for reacting loads from tool working processes such as spraying or grinding, may be passive damping, relying on dissipation of the kinetic energy into the structure of the tool and its environs. Alternatively, the tool may be equipped to enable active damping control. In this case, the tool may be equipped with one or more actuators and a control circuit, possibly comprising a processor and control program, and the IMU may be used to sense the motion of the tool and pass the information describing the motion to the control circuit, the control circuit configured to cause movement of the one or more actuators to actively damp motion of the tool. In some instances, the actuators may be configured to actuate an area of articulation in the tool. In other instances, the actuators may be provided for another purpose, or for the sole purpose of active damping. After anchoring by any of the means described in US Patent U.S. Pat. No. 10,920,590B2 or any other suitable and secure means, the end effector may be released from the tool and the tool may be retracted from the engine, at least to the extent necessary to allow free rotation of at least some of the gas turbine engine rotor components. During rotation of the rotor component(s), an IMU within the end effector 701 may further be used to determine the amount of rotation of the rotor component(s), to provide rotational odometry for the end effector, for example to enable the position of the end effector to be recorded along with the output(s) of sensor(s) mounted to the end-effector 701, so as to localise the sensor targets. In this manner, the identity and location of defects or articles of interest within the engine may be recorded. The position of the end effector may also be monitored in a similar manner, for other maintenance activities, for example to cause a spray tool to release a spray material at a predetermined location within the engine. In a further example, the rotational position of the rotor may be used to enable an end effector to perform a grinding operation on a specific stator component within the gas turbine engine, for example on a nozzle aerofoil. After performance of the maintenance activity by the end effector, the tool may be reintroduced into the gas turbine engine to retrieve the end effector. For this purpose, the end effector IMU may be used to confirm the precise angular position of the end effector, to assist with reconnecting the tool to the end effector. Further, if both the end effector and tool are equipped with IMU's, the outputs of both IMU's may be compared to ensure angular alignment of attachment features on the interface components of the end effector and tool, to ensure the attachment features align and engage without difficulty, which might otherwise arise from misalignment.

As noted above, by one approach a desired maintenance activity may comprise inspecting some interior feature of a gas turbine engine. In this case, the effector 701 may include a still and/or video camera. These teachings will accommodate providing the corresponding images either live via a wired or wireless link and/or to an onboard memory to support the viewing of that content at a later time when the tool 102 is withdrawn from the gas turbine engine. By one approach, IMU feedback as described above can be leveraged to move the tool 102 and effector 701 to particular locations/positions to observe, for example, defects or to facilitate, for example, making one or more measurements within the gas turbine engine. By one approach, these teachings will accommodate using IMU feedback to set a particular position and pose of the effector 701 to thereby yield a standardized field of view when conducting a visual inspection.

Also as noted above, by one approach a desired maintenance activity may comprise repairing some interior feature of a gas turbine engine. In this case, the effector 701 may be configured to execute a particular repair function as a location that is accessed via the tool 102.

One example of a repair function can comprise surface preparation. Examples in these regards include peening (via, for example, shot or needle) to impose compressive stresses on a particular surface. Another example in these regards comprises grit blasting a surface in preparation for follow-on procedures such as a coating application. In both of these regards, the IMU's of the tool 701 can be utilized to assess tool stability in view of reaction forces corresponding to the repair functionality during use and to provide corresponding motion-based compensation in turn.

Another example of a repair function can comprise the application of adherent material to a surface within the gas turbine engine, for example, by painting/spraying. Useful coatings in these regards might include, but are not limited to, sprayed materials such as Thermal Barrier Coatings (TBC) or Environmental Barrier Coating (EBC) slurries. In these regards, IMU feedback can be utilized, for example, to set correct positions, to compensate for vibration while spraying, and/or to compensate for motion errors while administering a particular spray pattern.

Another example of painting/spraying can comprise patching sections of spalled and/or eroded coatings. As an illustrative example, the latter could comprise painting/spraying to repair a partial loss of TBC material on a combustor section of the gas turbine engine. In such a case, IMU feedback can again be employed to set correct positions, to compensate for vibration while spraying, and/or to compensate for motion errors while administering a particular spray pattern.

Another example of a repair function can comprise smearing, such as spackling patching material over surfaces having spalled coatings. In this case, IMU capabilities of the tool 102 can serve to help guide the tool 102 to the location requiring this repair and can also help to facilitate the motion that is desired the effect the repair.

Another example of a repair function can comprise the removal of material, such as a build-up of combustion products on a given surface. To support this repair activity, the effector 701 may have an abrading capability or a thermal capability that can serve to remove the material of concern.

As another example in these regards, the effector 701 may have a drilling capability to support drilling holes in order to stop cracks or to introduce new holes to change, for example, a cooling flow distribution to mitigate observed thermal damage. Feedback from the IMU's can be utilized to gain access to the repair location and also to support the requisite motion to conduct the repair.

As yet another example in these regards, the effector 701 may be configured to facilitate such things as blending nicks and dings that may have occurred through interaction with a foreign object or even a domestic object (for example, on an airfoil). In use cases like these, the IMU's feedback can facilitate accessing the blend location and can also support the motion required to conduct the repair.

Another example of a repair function can comprise joining materials, for example, by welding or brazing. Welding may be facilitated by using an effector 701 having a laser capability to do local welding. Brazing may be facilitated by having the effector 701 apply braze material (for example, as a paste or powder) in locations where joints have failed or where cracks are observed, followed by an in situ heat treatment to form the braise joint.

So configured, these teachings support using multiple inertial measurement units across multiple areas of articulation to support generating absolute references for orientation, the latter being suitable to enable, for example, initialization in any pose across multiple rotations/articulations without necessarily requiring further movement of the tool. These teachings can be employed with a wide variety of tools including, for example, articulated robot arms, so-called robotic snake arms, and any of a wide variety of effectors.

It will be appreciated that use of the positional proprioception information described herein can be used for navigation purposes, for example, by estimating the positioning of the tool relative to a given deployment space within a gas turbine engine. For example, the deployment space can comprise a position around a combustor chamber, a position relative to a fuel nozzle, or a position relative to a specific blade stage. Other navigational purposes can be served as well, including the use of closed-loop feedback to correct for any positioning error of the tool and/or its effector(s) or to allow for precise inspections and/or repairs.

The positional proprioception information can also be leveraged to provide physical/mechanical stability while conducting a given maintenance activity. As one example, feedback from an accelerometer can be used to estimate the stability of the effector 701 during an inspection or repair activity. As another example, the available information can allow for residual vibration to completely dampen following a selective movement of the tool and/or the effector before performing a given inspection or repair. As yet another example, the available information can permit the monitoring of vibration while performing an inspection or repair to help gauge the acceptability of the corresponding results. And as yet another example, the available information can provide for monitoring vibration while performing an inspection or repair to provide a basis for conducting adaptive damping or other vibration compensation.

Further aspects of the disclosure are provided by the subject matter of the following clauses:
Clause 1. An apparatus for maintaining a gas turbine engine having at least one port, the apparatus comprising: a tool having an end effector to effect maintaining the gas turbine engine, the tool being configured to temporarily enter and exit the gas turbine engine via the at least one port and having a first portion and a second portion separated by at least a first area of articulation, wherein the first area of articulation provides at least two degrees of freedom of movement; a first inertial measurement unit (IMU) affixed with respect to the first portion; a second IMU affixed with respect to the second portion; and a control circuit operably coupled to the first IMU and the second IMU and configured to: receive first information from the first IMU regarding the first portion and receive second information from the second IMU regarding the second portion while the tool effects the maintaining of the gas turbine engine; process the first information and the second information to generate positional proprioception information as regards the first portion with respect to the second portion; and control stability of at least the end effector while the tool effects the maintaining of the gas turbine engine as a function, at least in part, of the positional proprioception information.
Clause 2. The apparatus of clause 1, wherein at least one of the first and second IMU includes at least three gravity-based orientation sensors and at least three non-gravitational acceleration sensors.
Clause 3. The apparatus of clause 1 wherein the first area of articulation provides at least three degrees of freedom of movement.
Clause 4. The apparatus of clause 1 wherein at least a portion of the tool is contained within a flexible cover
Clause 5. The apparatus of clause 1 wherein the control circuit is configured to generate the positional proprioception information as a function, at least in part, of sensor fusion.
Clause 6. The apparatus of clause 1 wherein the control circuit is configured to generate the positional proprioception information without use of through-drivetrain information.
Clause 7. The apparatus of clause 1 wherein the maintaining comprises inspecting an internal feature of the gas turbine engine while at least the first portion of the tool is fully disposed within the gas turbine engine and within the at least one port.
Clause 8. The apparatus of clause 1 wherein the maintaining comprises repairing an internal feature of the gas turbine engine while at least the first portion of the tool is fully disposed within the gas turbine engine and within the at least one port.
Clause 9. The apparatus of clause 8 wherein the repairing comprises at least one of: preparation of a surface of an internal feature of the gas turbine engine; applying a material to an internal feature of the gas turbine engine; removing material from an internal feature of the gas turbine engine; joining materials within the gas turbine engine.
Clause 10. The apparatus of clause 1 wherein the control circuit is further configured to navigate the tool within at least one tightly confined internal space within the gas turbine engine as a function, at least in part, of the positional proprioception information to a location where the tool can effect the maintaining of the gas turbine engine.
Clause 11. A method for maintaining a gas turbine engine having at least one port, the method comprising: disposing, within the gas turbine engine and via the port, a tool having: an end effector to effect maintaining the gas turbine engine, the tool being configured to temporarily enter and exit the gas turbine engine via the at least one port and having a first portion and a second portion separated by at least a first area of articulation, wherein the first area of articulation provides at least two degrees of freedom of movement; a first inertial measurement unit (IMU) affixed with respect to the first portion; a second IMU affixed with respect to the second portion; and a control circuit operably coupled to the first IMU and the second IMU; by the control circuit: receiving first information from the first IMU regarding the first portion and receive second information from the second IMU regarding the second portion while the tool effects the maintaining of the gas turbine engine; processing the first information and the second information to generate positional proprioception information as regards the first portion with respect to the second portion; and controlling stability of at least the end effector while the tool effects the maintaining of the gas turbine engine as a function, at least in part, of the positional proprioception information.
Clause 12. The method of clause 11, wherein at least one of the first and second IMU includes at least three gravity-based orientation sensors and at least three non-gravitational acceleration sensors.
Clause 13. The method of clause 11 wherein the first area of articulation provides at least three degrees of freedom of movement.
Clause 14. The method of clause 11 wherein at least a portion of the tool is contained within a flexible cover.
Clause 15. The method of clause 11 wherein the control circuit is configured to generate the positional proprioception information as a function, at least in part, of sensor fusion.
Clause 16. The method of clause 11 wherein generating the positional proprioception information comprises generating the positional proprioception information without use of through-drivetrain information.
Clause 17. The method of clause 11 wherein the maintaining comprises inspecting an internal feature of the gas turbine engine while at least the first portion of the tool is fully disposed within the gas turbine engine and within the at least one port.
Clause 18. The method of clause 11 wherein the maintaining comprises repairing an internal feature of the gas turbine engine while at least the first portion of the tool is fully disposed within the gas turbine engine and within the at least one port.
Clause 19. The method of clause 18 wherein the repairing comprises at least one of: surface preparation of a surface of an internal feature of the gas turbine engine; applying a material to an internal feature of the gas turbine engine; removing material from an internal feature of the gas turbine engine; joining materials within the gas turbine engine.
Clause 20. The method of clause 11 further comprising, by the control circuit: navigating the tool within at least one tightly confined internal space within the gas turbine engine as a function, at least in part, of the positional proprioception information to a location where the tool can effect the maintaining of the gas turbine engine.

Those skilled in the art will recognize that a wide variety of modifications, alterations, and combinations can be made with respect to the above-described embodiments without departing from the scope of the disclosure, and that such modifications, alterations, and combinations are to be viewed as being within the ambit of the inventive concept.

What is claimed is:

1. An apparatus for maintaining a gas turbine engine having at least one port, the apparatus comprising:
a tool having an end effector to effect maintaining the gas turbine engine, the tool being configured to temporarily enter and exit the gas turbine engine via the at least one port and having a first portion and a second portion separated by at least a first area of articulation, wherein the first area of articulation provides at least two degrees of freedom of movement;
a first inertial measurement unit (IMU) affixed with respect to the first portion;
a second IMU affixed with respect to the second portion; and
a control circuit operably coupled to the first IMU and the second IMU and configured to:
receive first information from the first IMU regarding the first portion and receive second information from the second IMU regarding the second portion while the tool effects the maintaining of the gas turbine engine;
process the first information and the second information to generate positional proprioception information as regards the first portion with respect to the second portion; and
control stability of at least the end effector while the tool effects the maintaining of the gas turbine engine as a function, at least in part, of the positional proprioception information.

2. The apparatus of claim 1, wherein at least one of the first and second IMU includes at least three gravity-based orientation sensors and at least three non-gravitational acceleration sensors.

3. The apparatus of claim 1, wherein the first area of articulation provides at least three degrees of freedom of movement.

4. The apparatus of claim 1, wherein at least a portion of the tool is contained within a ovcer.

5. The apparatus of claim 1, wherein the control circuit is configured to generate the positional proprioception information as a function, at least in part, of sensor fusion.

6. The apparatus of claim 1, wherein the control circuit is configured to generate the positional proprioception information without use of through-drivetrain information.

7. The apparatus of claim 1, wherein the maintaining comprises inspecting an internal feature of the gas turbine engine while at least the first portion of the tool is fully disposed within the gas turbine engine and within the at least one port.

8. The apparatus of claim 1, wherein the maintaining comprises repairing an internal feature of the gas turbine engine while at least the first portion of the tool is fully disposed within the gas turbine engine and within the at least one port.

9. The apparatus of claim 8, wherein the repairing comprises at least one of:
preparation of a surface of an internal feature of the gas turbine engine;
applying a material to an internal feature of the gas turbine engine;
removing material from an internal feature of the gas turbine engine;
joining materials within the gas turbine engine.

10. The apparatus of claim 1, wherein the control circuit is further configured to navigate the tool within at least one tightly confined internal space within the gas turbine engine as a function, at least in part, of the positional proprioception information to a location where the tool can effect the maintaining of the gas turbine engine.

11. A method for maintaining a gas turbine engine having at least one port, the method comprising:
disposing, within the gas turbine engine and via the port, a tool having:
an end effector to effect maintaining the gas turbine engine, the tool being configured to temporarily enter and exit the gas turbine engine via the at least one port and having a first portion and a second portion separated by at least a first area of articulation, wherein the first area of articulation provides at least two degrees of freedom of movement;
a first inertial measurement unit (IMU) affixed with respect to the first portion;
a second IMU affixed with respect to the second portion; and
a control circuit operably coupled to the first IMU and the second IMU;
by the control circuit:
receiving first information from the first IMU regarding the first portion and receiving second information from the second IMU regarding the second portion while the tool effects the maintaining of the gas turbine engine;
processing the first information and the second information to generate positional proprioception information as regards the first portion with respect to the second portion; and
controlling stability of at least the end effector while the tool effects the maintaining of the gas turbine engine as a function, at least in part, of the positional proprioception information.

12. The method of claim 11, wherein at least one of the first and second IMU includes at least three gravity-based orientation sensors and at least three non-gravitational acceleration sensors.

13. The method of claim 11, wherein the first area of articulation provides at least three degrees of freedom of movement.

14. The method of claim 11, wherein at least a portion of the tool is contained within a flexible cover.

15. The method of claim 11, wherein the control circuit is configured to generate the positional proprioception information as a function, at least in part, of sensor fusion.

16. The method of claim 11, wherein generating the positional proprioception information comprises generating the positional proprioception information without use of through-drivetrain information.

17. The method of claim 11, wherein the maintaining comprises inspecting an internal feature of the gas turbine engine while at least the first portion of the tool is fully disposed within the gas turbine engine and within the at least one port.

18. The method of claim 11, wherein the maintaining comprises repairing an internal feature of the gas turbine engine while at least the first portion of the tool is fully disposed within the gas turbine engine and within the at least one port.

19. The method of claim 18, wherein the repairing comprises at least one of:
surface preparation of a surface of an internal feature of the gas turbine engine;
applying a material to an internal feature of the gas turbine engine;
removing material from an internal feature of the gas turbine engine;
joining materials within the gas turbine engine.

20. The method of claim 11, further comprising, by the control circuit:
navigating the tool within at least one tightly confined internal space within the gas turbine engine as a function, at least in part, of the positional proprioception information to a location where the tool can effect the maintaining of the gas turbine engine.
